(19) United States
(12) Patent Application Publication
(10) Pub. No.: US 2009/0037196 A1
(43) Pub. Date: Feb. 5, 2009

(54) DETERMINING WHETHER A POSTAL MAIL ITEM CONTAINING A RADIO FREQUENCY IDENTIFIER (RFID) IS JUNK MAIL

(76) Inventors: David Yu Chang, Austin, TX (US); John Yow-Chun Chang, Austin, TX (US); Syed-Muasir Khalll, Austin, TX (US); Vishwanath Venkataramappa, Austin, TX (US)

Correspondence Address: IBM CORP (YA);C/O YEE & ASSOCIATES PC, P.O. BOX 802333, DALLAS, TX, 75380, US

(21) Appl. No.: 11/830,964

(22) Filed: Jul. 31, 2007

(51) Int. Cl. G06Q 50/00

(52) U.S. Cl. 705/1

(57) ABSTRACT

A method, computer program product, and apparatus for receiving a postal mail item. The postal mail item is received. The postal mail item contains a radio frequency identifier identifying the sender of the postal mail item. Responsive to receiving the postal mail item in the mailbox, the radio frequency identifier of the postal mail item is scanned with a scanner to identify the sender of the postal mail item. A determination is made whether the sender of the postal mail item is in a junk mail list. The junk mail list includes a list of senders accessible to a processor in the scanner.

### BACKGROUND OF THE INVENTION

1. Field of the Invention

The present invention relates generally to postal mail and in particular to receiving postal mail. Still more particularly, the present invention relates to a computer implemented method, computer program product, and apparatus for identifying whether a postal mail item containing a radio frequency identifier (RFID) is junk mail.

2. Description of the Related Art

Many businesses use mass mailings to send mail containing information about a product or service the business offers to potential customers. Often, the business may purchase a mailing list of potential customers, and send the mail to the potential customers using the mailing list. If the recipient receiving the informational mail does not want the mail, the informational mail is known as “junk mail”.

When a mail recipient receives junk mail, the mail recipient spends time opening each mail item to determine which mail items are junk mail. In addition, the mail recipient may have to perform additional actions to discard the junk mail, such as shredding the junk mail, or marking the junk mail “return to sender” and placing the junk mail back in the postal system. Many mail recipients do not enjoy spending the time needed to identify and discard junk mail.

### SUMMARY OF THE INVENTION

The illustrative embodiments described herein provide a method of receiving a postal mail item. The postal mail item is received. The postal mail item contains a radio frequency identifier identifying the sender of the postal mail item. Responsive to receiving the postal mail item in the mailbox, the radio frequency identifier of the postal mail item is scanned with a scanner to identify the sender of the postal mail item. A determination is made whether the sender of the postal mail item is in a junk mail list. The junk mail list comprises a list of senders accessible to a processor in the scanner.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in accordance with an illustrative embodiment;

FIG. 2 is a block diagram of a data processing system in which illustrative embodiments may be implemented;

FIG. 3 is a block diagram of scanning a mail item in accordance with an illustrative embodiment;

FIG. 4 is a block diagram of a scanner in a mailbox in accordance with an illustrative embodiment;

FIG. 5 is a block diagram of sorting mail items in accordance with an illustrative embodiment; and

FIG. 6 is a flowchart of a process for receiving a postal mail item containing a radio frequency identifier (RFID) in accordance with an illustrative embodiment.

### DETAILED DESCRIPTION OF THE PREFERRED EMBODIMENT

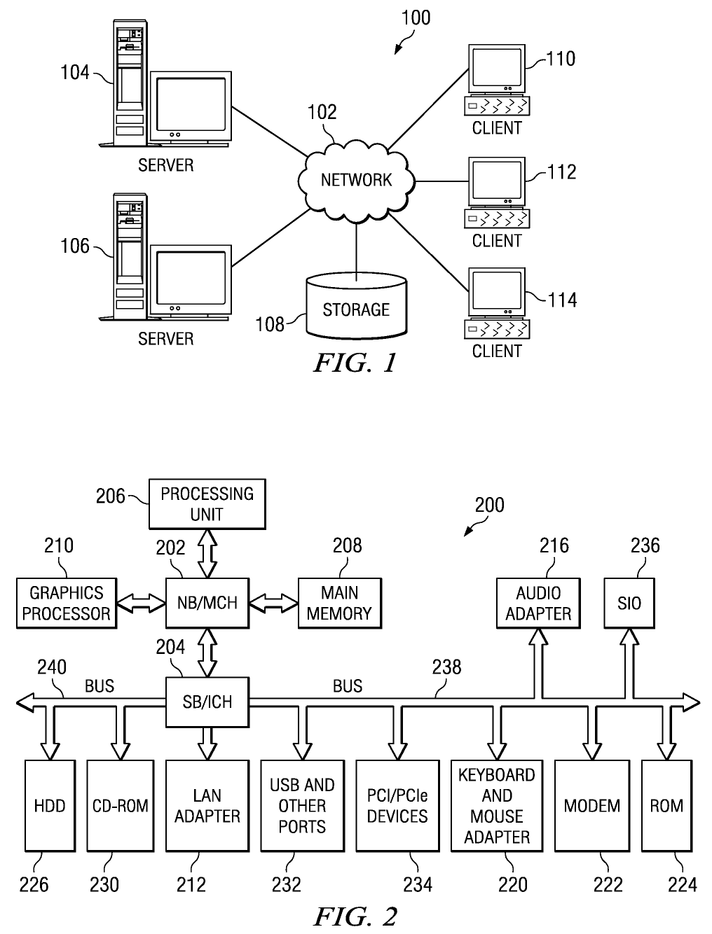

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The post office operates a postal system which gets mail items from senders, and delivers the mail items to mail recipients, such as individual residences and businesses. Often, if a sender is a business, the sender pays the post office to deliver copies of the same mail item to mail recipients. For example, if a new restaurant opens in a particular location, the restaurant may pay the post office to deliver a copy of the restaurant's menu to every mail recipient located in the area surrounding the location of the restaurant.

When a mail recipient receives a mail item which the mail recipient did not want, the mail item is known as junk mail. The sender of the junk mail may be a sender known to the mail recipient, or a sender unknown to the mail recipient. Often, mail recipients receive many mail items which are junk mail every day. Some mail recipients may occasionally receive more mail items which are junk mail than mail items which are not junk mail. Many mail recipients find that dealing with junk mail is time consuming because the mail recipient must sort through the mail items, identify the mail items which are junk mail, and discard the mail items identified as junk mail.

For example, the mail recipient may discard the mail items identified as junk mail by destroying the mail items. Alternately, the mail recipient may discard the mail items identified as junk mail by marking each mail item with “return to sender”, and placing the marked mail items back in the postal system. In addition, junk mail may cause mail items which are not junk mail to be accidentally discarded. For example, mail items which are not junk mail may be accidentally discarded if the mail recipient makes a mistake when sorting the mail items. The illustrative embodiments recognize that there is a need to identify junk mail when the junk mail is placed in the mail recipient's mailbox.

The illustrative embodiments described herein provide a method of receiving a postal mail item. The postal mail item is received. The postal mail item contains a radio frequency identifier identifying the sender of the postal mail item. Responsive to receiving the postal mail item in the mailbox, the radio frequency identifier of the postal mail item is scanned with a scanner to identify the sender of the postal mail item. A determination is made whether the sender of the postal mail item is in a junk mail list. The junk mail list comprises a list of senders accessible to a processor in the scanner.

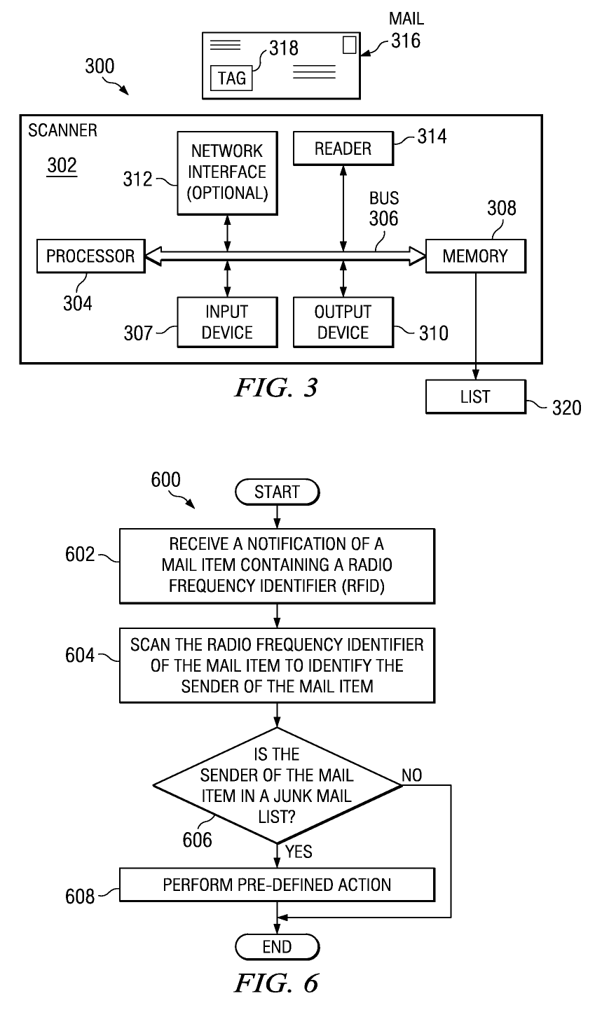

FIG. 3 is a block diagram of scanning a mail item in accordance with an illustrative embodiment. Scanning a mail item 300 contains scanner 302. Scanner 302 may be located in the mailbox of a mail recipient. Scanner 302 contains processor 304. Processor 304 may be a central processing unit, such as processing unit 206 in FIG. 2, or processor 304 may be an integrated circuit containing logic programmed to perform specific tasks. Processor 304 communicates with other components of scanner 302 using bus 306. Connected to bus 306 is input device 307. Input device 307 is used to accept input from a user. Input device 307 may be one or more devices for receiving user input, such as, for example, a microphone, a keypad, a keyboard, or a mouse.

Connected to bus 306 is output device 310. Output device 310 is used to output information to the user. Output device 310 may be one or more devices for outputting information, such as, for example, a speaker, a light emitting diode (LED) capable of displaying one or more colors, or a liquid crystal display (LCD) capable of displaying one or more alphanumeric characters. Connected to bus 306 is memory 308. Memory 308 is used to store data.

Network interface 312 is an optional component of scanner 302. If network interface 312 is present, network interface 312 may be used to connect scanner 302 to a network, such as network 102 in FIG. 1. By connecting scanner 302 to a network using network interface 312, a user on a remote client, such as client 110 in FIG. 1, can access and communicate with scanner 302. Connected to bus 306 is reader 314. Reader 314 is used to read the information in a radio frequency identifier (RFID) tag.

Mail 316 is a mail item delivered by the postal system to a mail recipient. Mail item 316 contains tag 318. Tag 318 is a radio frequency identifier. Tag 318 contains information about mail 316, including the identity of the sender of mail 316. In addition to the identity of the sender of mail 316, tag 318 may also contain additional information, such as, for example, the sender's address, the recipient's address, and routing information for routing mail 316 from the sender's address to the recipient's address.

Reader 314 is used to read information, such as the sender's name, from radio frequency identifier (RFID) tag 318. Tag 318 is in mail 316, and reader 314 is in scanner 302, therefore when mail 316 comes within a specified distance of scanner 302, reader 314 detects tag 318. In addition, when mail 316 comes within a specified distance of scanner 302, reader 314 can read the information in tag 318, such as the identity of the sender of mail 316. The specified distance may be set to a default value initially, and may be user configurable. For example, if the specified distance is six inches, reader 314 can detect, and read the information in tag 318 only when mail 316 is within six inches of scanner 302.

Memory 308 may contain list 320. List 320 is a list containing the identity of one or more senders of junk mail. List 320 is known as a junk mail list. The identity of each sender of junk mail may be one or more of the sender's name, the sender's mailing address, and a unique identifier identifying the sender.

When mail 316 comes within a specified distance of scanner 302, reader 314 notifies processor 304 that reader 314 has detected that mail 316 is in close proximity to scanner 302. Processor 304 requests reader 314 to read the information in tag 318, including information about the sender of mail 316. After reader 314 reads the information in tag 318, reader 314 provides processor 304 with the information in tag 318. Processor 304 determines whether the identity of the sender in tag 318 is in list 320. If processor 304 determines that the identity of the sender in tag 318 is in list 320, processor 304 may uses output device 310 to perform a pre-defined action specified by the mail recipient. For example, output device 310 may indicate to a user that the sender in tag 318 is in list 320, and therefore mail 316 is considered junk mail.

Output device 310 may be used in many different ways. For example, assume a postal employee brings mail 316 within a specified distance of a mailbox containing scanner 302. If processor 304 determines that the sender identifier in tag 318 is in list 320, processor 304 may use output device 310 to notify the postal employee that mail 316 is considered junk mail. If output device 310 is a speaker, the speaker may emit a loud buzzing noise or a pre-recorded announcement, such as, for example, “The mail item in the proximity of the mailbox is junk mail”. If output device 310 is a light emitting diode (LED), the light emitting diode may change color, such as, for example, from green to red. If output device 310 is a liquid crystal display (LCD), the liquid crystal display may display a message, such as, for example, “The mail item in the proximity of the mailbox is junk mail”. If output device 310 is an ink stamp, the ink stamp may be used to mark mail 316 with the words “return to sender”.

Processor 304 may perform other actions upon determining that the sender information in tag 318 is in list 320. For example, if a shredder is located near scanner 302, processor 304 may send a message to a mechanical device, such as a robotic arm or pinch rollers, to destroy mail 316 by shredding mail 316.

Scanner 302 may also be used to update list 418. For example, assume the sender of mail 316 is not in list 320. If a recipient of mail 316 determines that the sender of mail 316 should be added to list 320 because mail 316 the recipient considers mail 316 junk mail, the recipient can use input device 307 to notify processor 304. Processor 304 can ask the mail recipient to bring mail 316 within the specified distance of scanner 302, use reader 314 to scan the sender information in tag 318, and add the sender information to list 320.

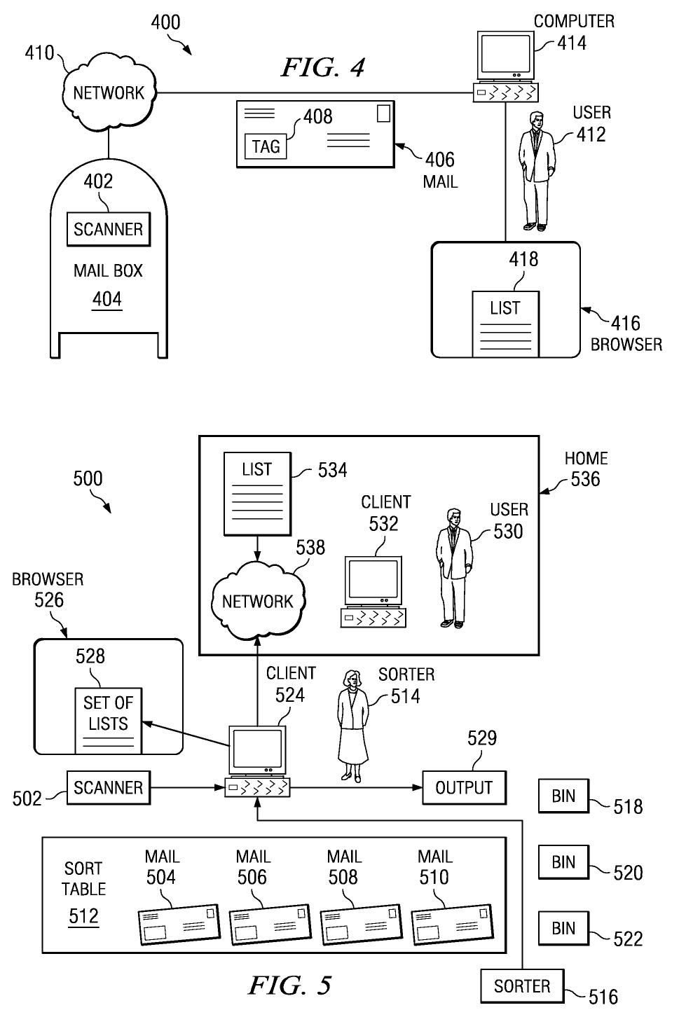

FIG. 4 is a block diagram of a scanner in a mailbox. In scanner in a mailbox 404, scanner 402 is a scanner for scanning radio frequency identifiers, such as scanner 302 in FIG. 3. Scanner 402 is inside mailbox 404. Mailbox 404 may be located near the residence of a mail recipient, or mailbox 404 may be located in a post office. Mail 406 is a mail item, such as mail 316. Mail item 406 contains tag 408. Tag 408 is a radio frequency identifier (RFID), such as tag 318 in FIG. 3.

When mail 406 is within a specified distance of scanner 402 in mailbox 404, scanner 402 reads the sender information in tag 408. Scanner 402 then determines if the sender is in a junk mail list, such as list 320, and takes appropriate action, such as, for example, notifying the person handling mail 406 that mail 406 is considered junk mail.

If scanner 402 contains an optional network interface, such as network interface 312 in FIG. 3, scanner 402 may be connected to network 410. Network 410 may be a local network created by a mail recipient who uses mailbox 404. Alternately, network 410 may be a network, such as network 102 in FIG. 1. Network 410 may be a wired network using a protocol such as Ethernet. Alternately, network 410 may be a wireless network using a protocol such as Bluetooth, wireless universal serial bus (USB), or 802.11.

If scanner 402 is connected to network 410, a mail recipient, such as user 412, may use computer 414 to communicate with scanner 402. For example, user 412 may use computer 414 to open browser 416 and view list 418. Browser 416 may, for example, be an internet browser, or a document editor. List 418 is a list of senders of junk mail, such as list 320 in FIG. 3. List 418 may be contained in a memory in scanner 402, such as memory 308. User 412 may use browser 416 to view list 418 using network 410. User 412 may also use browser 416 to modify list 418 by adding entries to, or removing entries from list 418, and then storing list 418 back in scanner 402 using network 410.

FIG. 5 is a block diagram of sorting mail items in accordance with an illustrative embodiment. In scanner in a postal sorting environment 500, scanner 502 is used in a postal sorting environment. Scanner 502 is a scanner, such as scanner 302 in FIG. 3. A postal sorting environment is a facility in which mail items are sorted, such as a post office, or a postal sorting facility.

Mail 504, 506, 508, and 510 are mail items, such as mail 406 is FIG. 4. Mails 504-510 are placed on sort table 512. Sort table 512 is a table for holding mail items for sorting. Sort table 512 may have a conveyer belt or other mechanism for moving mails 504-510 to sorters 514-516. Sorter 514 is a person who sorts mail. Sorter 516 is an automated sorting machine for sorting mail. Sorters 514-516 sort mail items, such as mails 504-510, by placing each mail item in a bin, such as bins 518, 520, 522. Each bin is associated with an action performed on the mail items in the bin. For example, bin 518 may be used to store mail items for forwarding to the recipient of the mail item. Bin 520 may be used to store mail items returned to the sender, because the recipient of each mail item did not wish to receive the mail item. Bin 522 may be used to store mail items for discarding.

Scanner 502 is connected to client 524. Client 524 is a client, such as client 110 in FIG. 1. Browser 526 is browser, such as browser 416 in FIG. 4. Browser 526 may be used to view and modify set of lists 528. Set of lists 528 is a set of junk mail lists. A set of junk mail lists is one or more junk mail lists. Each junk mail list in set of lists 528 is a junk mail list for a mail recipient.

In this example, assume at least one mail item in mails 504-510 contains a radio frequency identifier (RFID) tag. When a mail item, such as mail item 504, containing a radio frequency identifier (RFID) tag is brought near scanner 502, scanner 502 reads the radio frequency identifier (RFID) tag. Scanner 502 extracts information from the radio frequency identifier (RFID) tag of the mail item. Scanner 502 determines whether the sender of the mail item is in a junk mail list in set of lists 528. Based on the determination, scanner 502 may use output 529 to inform sorter 514 to perform an action on the mail item. For example, if output 529 is an alpha-numeric display, scanner 502 may use output 529 to display a message to sorter 514 to place a mail item, such as mail item 510, in a bin, such as bin 518. If output 529 is a loudspeaker, a message, such as “Place mail item in bin 518” may be played.

User 530 is a recipient of mail items. User 530 uses client 532 to create, and modify list 534. Client 532 is a client, such as computer 414 in FIG. 4. List 534 is a junk mail list, such as list 418 in FIG. 4. Client 534 is located in home 536 of user 530. Client 534 is connected to client 524 in the postal sorting facility using network 538. List 534 is used to periodically updated set of lists 528. For example, user 530 may update list 534, and then send list 534, and a request to update set of lists 528 using list 534. Alternately, client 524 may periodically check with client 532 to determine if list 534 is newer than the information in set of lists 528.

FIG. 6 is a flowchart of a process for receiving a postal mail item containing a radio frequency identifier (RFID). The process in FIG. 6 is executed by a processor, such as processor 304 in FIG. 3. The process begins when the processor receives notification of a mail item containing a radio frequency identifier (step 602). The radio frequency identifier in the mail item is scanned to identify the sender of the mail item (step 604). A determination is made as whether the sender of the mail item is in a junk mail list (step 606). If the answer is “no” and the sender of the mail item is not in the junk mail list, then the process ends. If the answer is “yes” and the sender of the mail item is in the junk mail list, then the process performs a pre-defined action (step 608) and the process ends.

Thus, the illustrative embodiments described herein provide a method of receiving a postal mail item. The postal mail item is received. The postal mail item contains a radio frequency identifier identifying the sender of the postal mail item. Responsive to receiving the postal mail item in the mailbox, the radio frequency identifier of the postal mail item is scanned with a scanner to identify the sender of the postal mail item. A determination is made whether the sender of the postal mail item is in a junk mail list. The junk mail list comprises a list of senders accessible to a processor in the scanner.

There are several advantages to using a scanner as described above when receiving mail items containing a radio frequency identifier (RFID). Mail items can be quickly sorted, using the scanner to identify junk mail, with fewer errors than if a mail recipient manually attempted to sort the mail items. Moreover, when the scanner is in a mailbox, the scanner can perform one or more pre-defined actions, including notifying a postal employee to return the junk mail to the sender. When the scanner performs one or more pre-defined actions, depending on the type of action performed, the junk mail may not be physically present in the mail recipient's mail box, freeing the mail recipient from dealing with the junk mail entirely.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of receiving a postal mail item, the method comprising:
receiving, in a mailbox, the postal mail item, wherein the postal mail item contains a radio frequency identifier in the sender of the postal mail item, wherein the sender is identified by the sender's name or the sender's mailing address;
responsive to receiving the postal mail item in the mailbox, scanning the radio frequency identifier on the postal mail item to identify the sender of the postal mail item;
determining whether the sender of the postal mail item is in a junk mail list, wherein the junk mail list comprises a list of senders accessible to a processor in the mailbox scanner; and
notifying a postal employee that the postal mail is in the junk mail list, wherein the notifying is selected from the list consisting of a buzzing noise, a prerecorded announcement, a color change of a light emitting diode, a displayed message, and marking the postal mail return to sender.

2. (canceled)

3. A method of receiving a postal mail item, them method comprising:
receiving the postal mail item, wherein the postal mail item contains a radio frequency identifier, identifying the sender of the postal mail item, wherein the sender is identified by the sender's name or the sender's mailing address;
responsive to receiving the postal mail item, scanning the radio frequency identifier of the postal mail with a scanner to identify the sender of the postal mail item;
determining whether the sender of the postal mail item is in a junk mail list, wherein the junk mail list comprises a list of senders accessible to a processor in the scanner; and
notifying a postal employee that the postal mail is in the junk mail list, wherein the notifying is selected from the list consisting of a buzzing noise, a prerecorded announcement, a color change of a light emitting diode, a displayed message, and marking the postal mail return to sender.

4. (canceled)

5. The method of claim 3, further comprising:
responsive to the processor in the scanner determining that the sender of the postal mail item is in the junk mail list, using the processor to update the junk mail list.

6. The method of claim 3, wherein the scanner is located in one of a post office, and a mailbox of a recipient of the postal mail item.

7. The method of claim 3, wherein the processor in the scanner communicates with a computer of a recipient of the postal mail item.

8. The method of claim 7, wherein the recipient of the postal mail item accesses the junk mail list on the computer using a web browser.

9. The method of claim 3, further comprising:
responsive to the processor in the scanner determining that the sender of the postal mail item is not in the junk mail list.
requesting the processor to add the sender of the postal mail item to the list of senders in the junk mail list.

10. A computer program product comprising a computer-readable medium including computer usable program code for receiving a postal mail item, the computer program product comprising:
computer usable code for receiving the postal mail item, wherein the postal mail item contains a radio frequency identifier identifying the sender of the postal mail item, wherein the sender is identified by the sender's name or the sender's mailing address;
responsive to receiving the postal mail item, computer usable code for scanning the radio frequency identifier of the postal mail item with a scanner to identify the sender of the postal mail item;
computer usable code for determining whether the sender of the postal mail item is in a junk mail list, wherein the junk mail list comprises a list of senders accessible to a processor in the scanner; and
notifying a postal employee that the postal mail is in the junk mail list, wherein the notifying is selected from the list consisting of a buzzing noise, a prerecorded announcement, a color change of a light emitting diode, a displayed message, and marking the postal mail return to sender.

11. (canceled)
